(19) United States
(12) Patent Application Publication
(10) Pub. No.: US 2004/0123315 A1
(43) Pub. Date: Jun. 24, 2004

(54) Pc based tv set-top box system and method for providing contents exclusively by the system

(76) Inventor: In-Sik Na, Seoul (KR)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/474,407

(22) PCT Filed: Apr. 10, 2002
(86) PCT No.: PCT/KR02/00638

(30) Foreign Application Priority Data
Apr. 10, 2001 (KR) 2001/19101
Jan. 10, 2002 (KR) 2002/01543

(51) Int. Cl. G06F 3/00; G06F 15/16

(52) U.S. Cl. 725/37; 709/229

(57) ABSTRACT

This disclosure provides a PC based set top box system to connect to a private site and a method of providing content exclusively using this system. This system includes a PC equipped with private browser operating software to operate a set top box to connect to a particular site and register user information when installing for the first time. Parallel communication is provided with set top box, which asks for log in permission to server when an operating order signal is received from set top box. Operating permission is sent when log in is permitted. Transmission of the PC's video and audio to the TV are provided when operation permission is received from PC. An exclusive offering of content is possible when connected to the Internet site permitted by the PC based TV set top box. The set top box includes software where it is possible to not allow access to other sites.

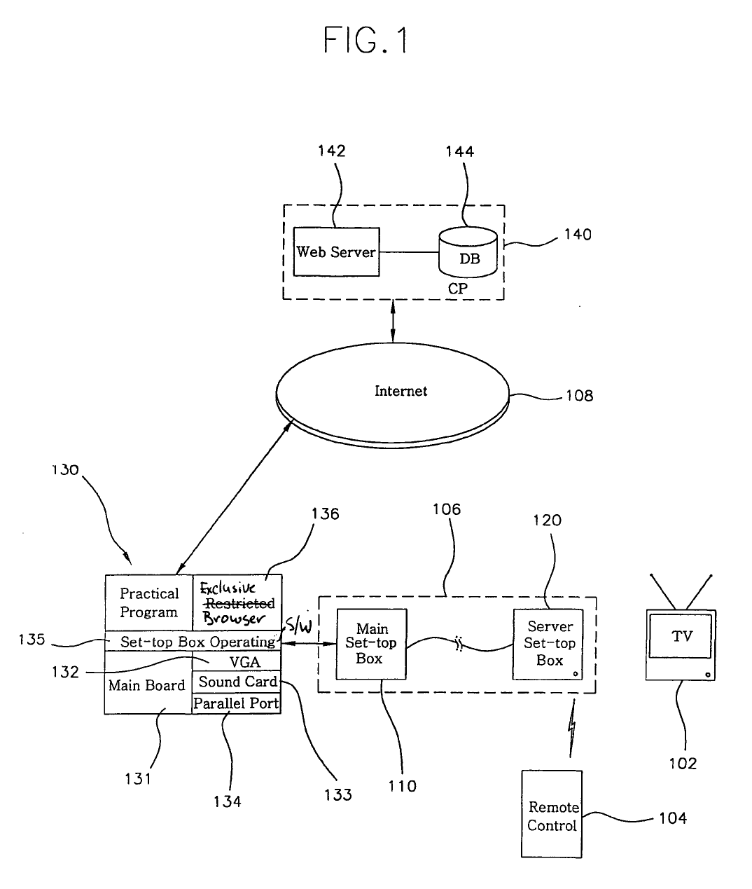

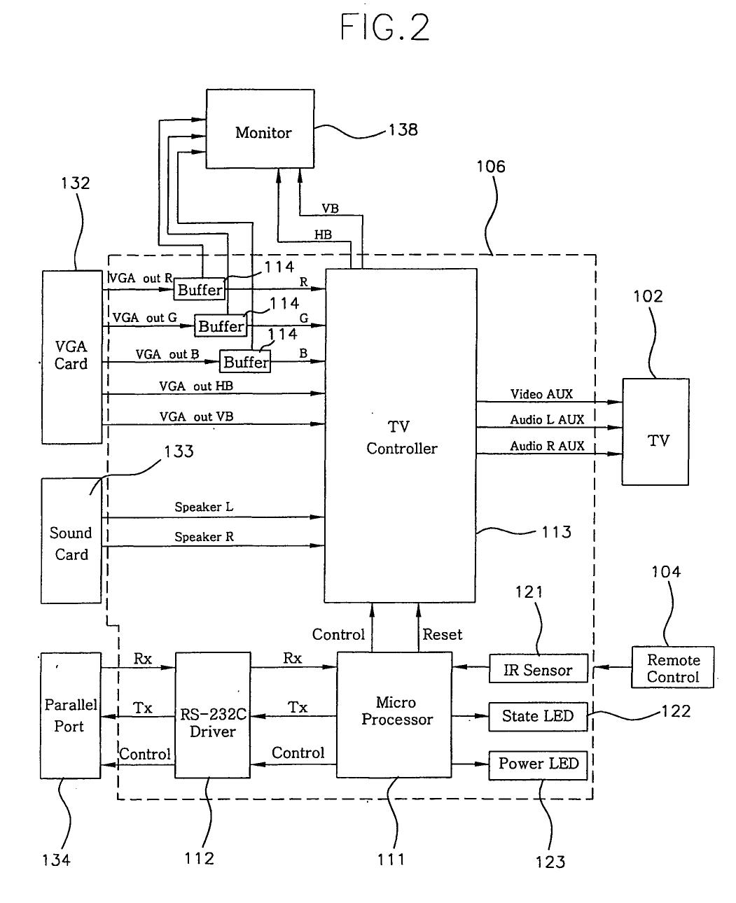

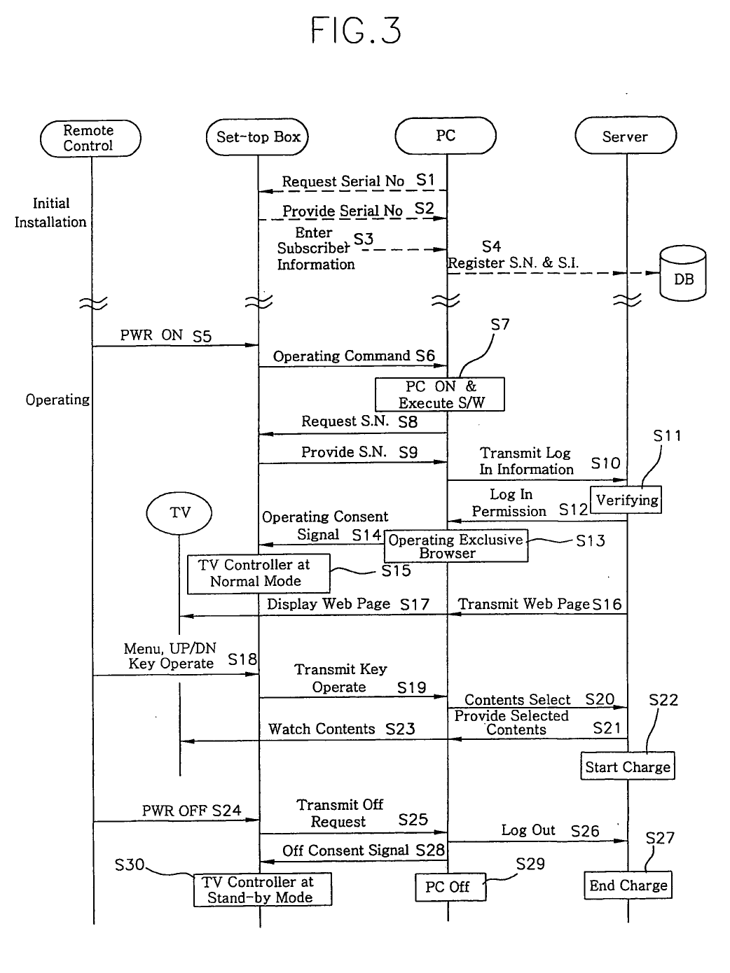

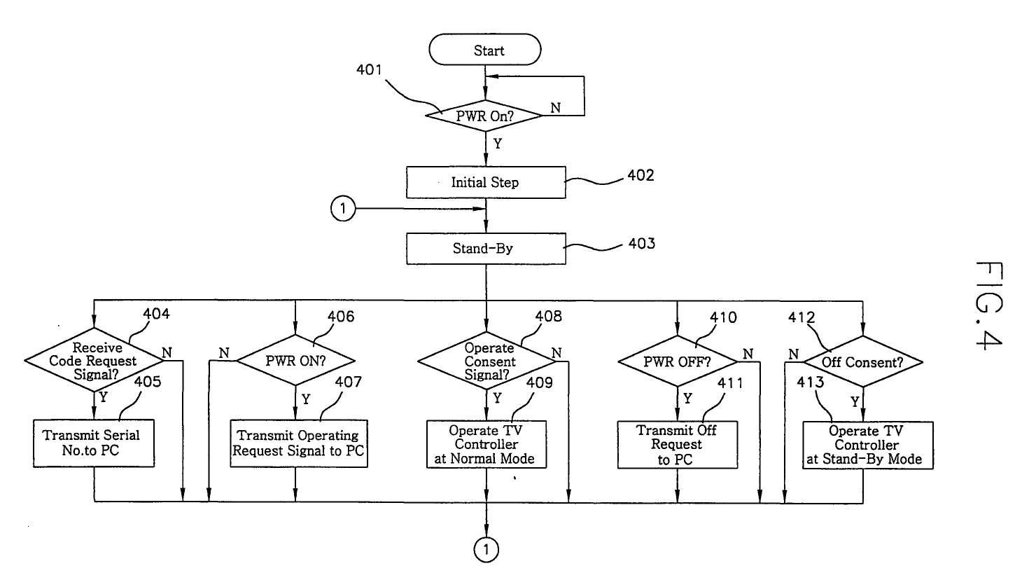

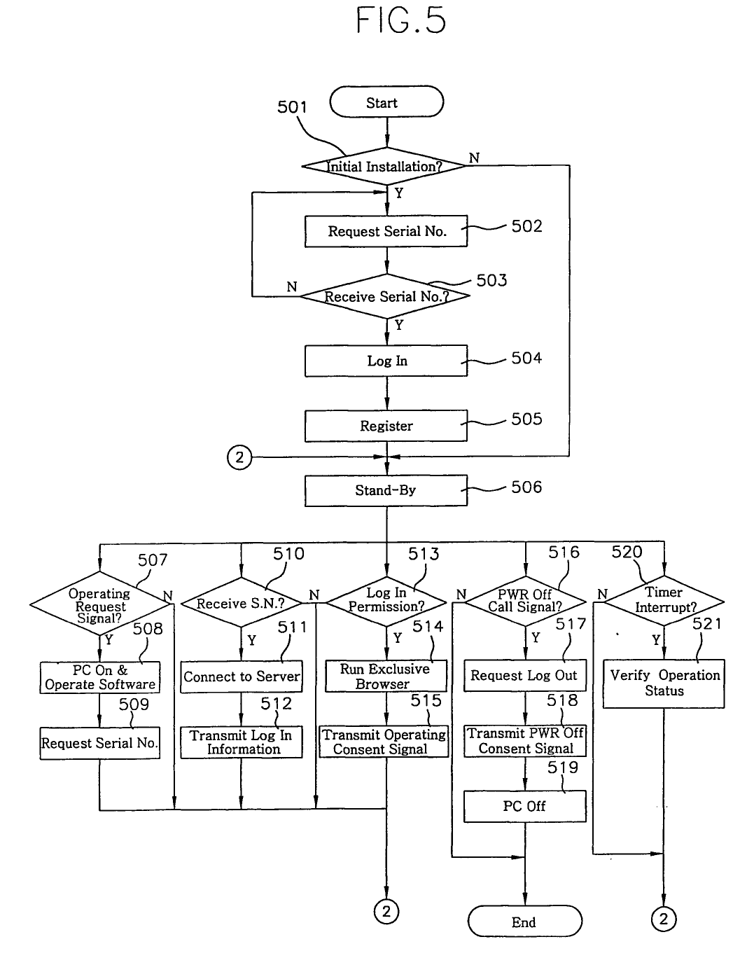

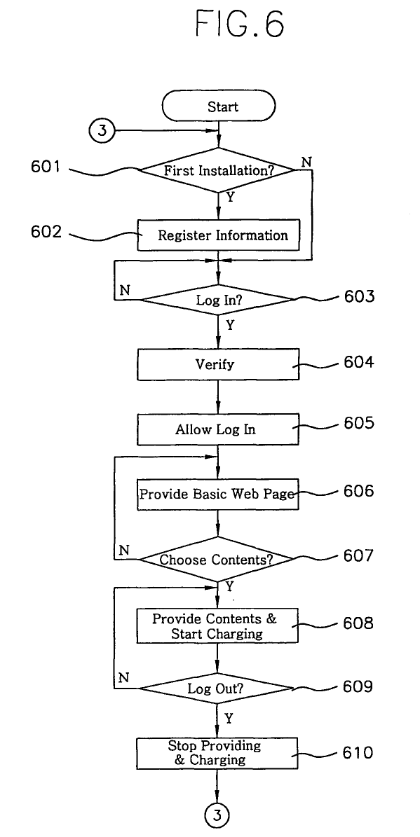

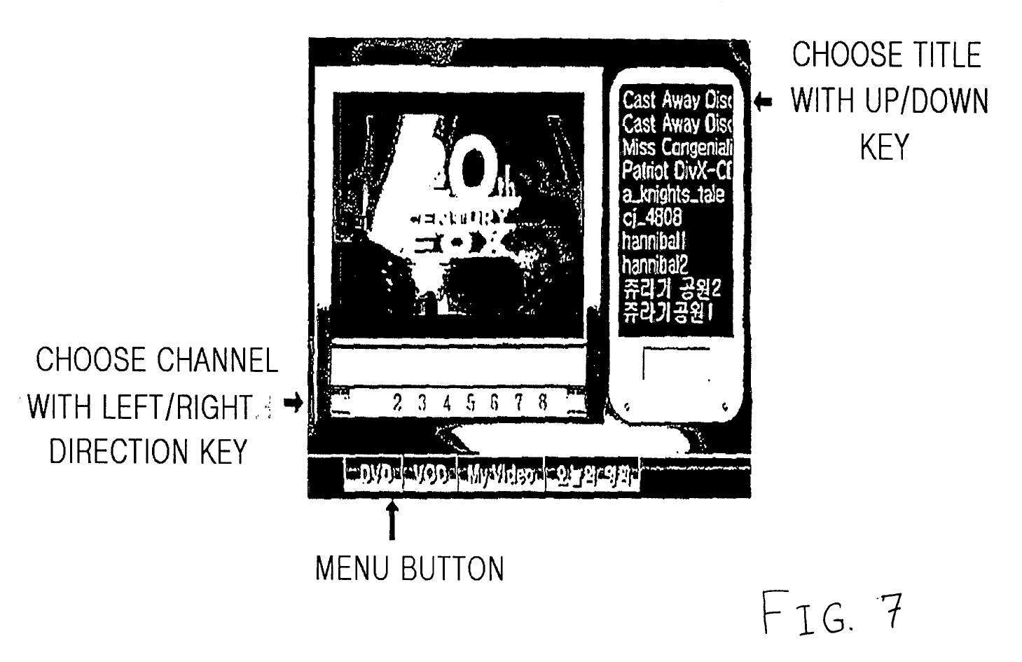

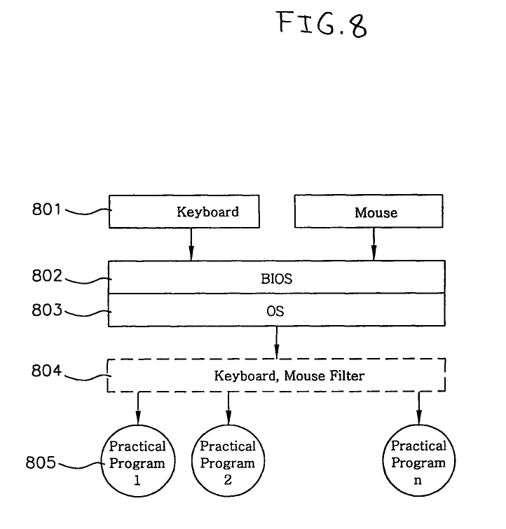

### TECHNICAL FIELD

This invention is about TV set top box using TV to connect internet, and in detail is about PC based set top box system to connect exclusive site only and method of providing contents exclusively by the system.

### BACKGROUND ART

Recently, internet connection using PC is common as internet use is broad, and supply of TV set top box is increasing gradually to use various service and contents by internet connection through home culture center medium TV.

This type of formal TV set top box connects to specified server by built in software, and should get service through this server but designed to surf internet site freely by user by having internet browser built in as basic.

In addition, since current service provided through internet is structured for user to choose contents provider, contents provider at this structure has no choice but to be in passive position waiting for user to connect after registering at virtual site.

Therefore, at current situation where internet users are at near saturated state, an increase in contents provider brings these market size relatively decrease and severe competition among business providers.

Therefore, if there is a way for contents provider to provide own contents exclusively to internet user reversing this structure, business foundation can be established surely.

### DISCLOSURE OF THE INVENTION

In order to satisfy above needs, this invention has purpose to provide TV set top box system which able to connect to particular site (contents provider) only and method of providing contents exclusively using this system.

### BEST MODE FOR CARRYING OUT THE INVENTION

In order to achieve above purpose, this invention system is specially composed of following devices; PC which operating software to operate private browser and set top box is loaded, registers password and subscriber's information at the site connecting to specific site at first time installation, parallel communicates with set top box and ask permission for log in to server when operating request signal is received from set top box, and then operates private browser and transmits operating permission to set top box after log in is permitted; key input device which user inputs to control set top box; and set top box which connects TV and above PC, requests for operation communicating with above PC when signal from above key input device is received, offers preset passcode when passcode request signal is received from above PC, and transmits above pc's video signal and audio signal to above TV operating normally when operating permit signal from above PC is received.

Furthermore, to achieve above goal, this invention specially includes following steps; a step to register passcode loaded at above set top box and subscriber information to site offering above contents at initial installation at the system where PC and TV connected through set top box, PC screen is featured at above TV and above PC is connected to contents exclusive site through internet; a step set top box transmits password and demands for operation communicating with above PC after motion requiring signal is received from input device; a step PC transmits password and subscriber information connecting to above site; a step above site compares and permits log in if received information is same with registered information; a step above PC operates private browser, receives above site's web page, and permits operation to above set top box after log in permission is received from above site; and a step above set top box transmits and indicates video signal and audio signal received from above PC to TV after operating permit signal is received.

At below, this invention's desirable examples will be explained referencing enclosed drawings.

At drawing 1 as a configuration diagram illustrating entire network according to this invention, TV (102) is connected to internet (108) through TV set top box (106) and PC (130), and contents provider (140) is connected to offer contents exclusively at internet (108) according to this invention. Even though TV set top box (106) interfacing TV (102) to internet (108) using PC (130) is possible to embody as one integration type when PC (130) and TV (102) are installed near by, usually it is recommended to embody main set top box (110) connected to PC (130) and server set top box (120) connected to TV (102) separately, and main set top box (110) and server set top box (120) are connected by cable when they are separated like this.

Referencing drawing 1, TV (102) is connected to server set top box (120), video AUX, audio 1 AUX, and audio R AUX. Furthermore, infrared sensor along with video and audio terminals are built in at server set top box (120), transmits operated signal to PC (130) through main set top box (110) when user operates wireless remote control, wireless keyboard, or wireless mouse in front of TV (102), and transmits video and audio signals received through main set top box (110) to TV (102) as is.

Main set top box (11) as described later changes video card (132) R,G,B signal installed at PC (13) to composite video for TV, controls TV controller (113 of drawing 2) which connects or disconnects audio signal and TV controller (113), equips micro processor (111 of drawing 2) to communicate with PC (130) and transmits operation request to PC (13) when set top box power on signal is received through server set top box (120), transmits already inputted ‘passcode’ when pssscode request is received from PC (130), and makes exclusive browser (136) screen to appear on TV (102) by operating TV controller (113) at normal mode when operating permission is received from PC (130).

PC (130) which is equipped with mainboard (131), video card (132), sound card (133), hardware including parallel communication port (134), set top box operating software (135) to operate set top box (106), operating software (136), and exclusive browser to connect to designated site only through set top box (106) transmits set top box (106) passcode when internet connection request (operation request) from set top box (106) and connects to server (142), transmits log in information (for example, passcode and subscriber ID, password etc.) And requests for log in, then exclusive browser screen is displayed at TV (102) through set top box (106) transmitting operating consent signal to set top box (106) when log in is granted from server (142).

Contents provider (140) equips web server (142) and data base (144) and manages subscriber storing set top box user's passcode and user information (for example, user ID, password, address, name, SSN, contact information, etc.) at data base (144), and approves verifying passcode and user information registered at data base (144) at the time of initial registration when log in is requested from PC (13) set top box operating program (137). And it provides basic web page (drawing 7), menu and link, which can choose various contents, and provides contents selected by user. Here, additional fee is charged when contents offered is with fee.

According to this invention like this, set top box (106) is operates only by PC (130) set top box operating software (135), set top box operating software (135) allows operation only with permission after reading password and verifying with contents provider (140) when set top box (106) operation is requested, and contents is provided exclusively by allowing access to selected contents provider (140) only through restricted browser (137).

Drawing 2 is a block diagram of illustrating set top box configuration according to this invention, this invention's set top box (106) is composed of micro processor (111), RS-232C driver (112), TV controller (113), buffer (114), infrared sensor (121), state led (122), power LED (123), and various cable connectors (not illustrated). Here, if set top box (109) is separated into main set top box (110) and server set top box (120), install micro processor (111), RS232C driver (112), TV controller (113), buffer (114) included in main set top box (110) near PC (130) and install video AUX, audio 1 AUX, audio R AUX, infrared sensor (121), LED (122, 123) included in server set top box (120) near TV (102).

Referencing to drawing 2, micro processor (111) transmits along fixed protocol connected to PC parallel port (134) as RX, TX, control signal line through RS232C driver (112), decodes this and transmits fixed format to PC (130) after receiving made up signal from remote control (104) through infrared sensor (121). And when power is on, mark power is authorized by turning on LED (123) and mark movement status at state LED (122).

Furthermore, TV controller (113) is controlled using reset signal and control signal.

TV controller (113) operates as ‘normal mode’ and ‘stand by mode’ according to micro processor (111) control signal. At ‘normal mode’, R,G,B signal (VGA out R, VGA out G, VGA out B), horizontal motor (VGA out HB), and vertical motor signal (VGA out VB) are inputted from video card (132) through buffer (114), R,G,B video signal converted to composite video signal is transmitted to server set top box (12) after audio signal (speaker L, speaker R) is inputted from sound card (133), and audio signal is transmitted to server set top box (120) as is. At ‘stand by mode’, video is not displayed on TV (102) by blocking video output and audio output. Moreover, when reset signal is inputted from micro processor (111), reset and operate from beginning again.

On drawing 3, as a step diagram illustrating contents providing process according to this invention, movement process between remote control (104) controlled by user and set top box (106), PC (130), server (140) is illustrated.

Referencing to drawing 3, after connecting set top box (106) with TV (102) and PC (130) at initial installation, install set top box operating software (135) and exclusive browser (136) to PC (130).

Subsequently, request for serial number communicating with set top box (106) through parallel communication port (134) running set top box operating software (135), then enter and register (S1-S4) serial number and subscriber information after logging in to server (142) after passcode is received from set top box (106). At this time, ‘serial number’ is a proper value (for example, 12 digit) stored at eeprom inside micro processor (111) when manufacturing set top box (106), and subscriber information is subscriber ID, password, address, name, social security number, contact point which set top box buyer (contents user) inputs to register after logging into contents provider's (140) server (142). These information stored at data base (144) provided to server (142) at initial subscription is used to manage subscriber (certification and excess charge, etc.).

When user (subscriber) turns remote control's (104) power on to use contents after subscription is completed like this, this signal is transmitted to set top box micro processor (111) through infrared sensor (121), and micro processor (111) decodes this and transmits operating command signal to PC (130) (S5, S6).

When operating command signal is received from set top box (106), turn PC (130) on, execute set top box operating software (135), and transmit serial number request order through parallel port (134) to set top box (106). When serial number is received from set top box (106), transmit required information for log in like this serial number, ID and password to server (142) (s7-s10). At this time, devices to control PC power should be equipped to control PC (130) on/off through set top box (106).

When log in information is received from PC (130), server (142) transmits log in permission to PC (130) verifying and if accords with stored registration information at data base (144). Thus, PC (130) operates exclusive browser (137) to view contents and provides operating consent signal to set top box (106).

Set top box (106) operates TV controller (113) at normal mode after receiving operating consent signal and transmits inputted signal from PC video card (132) and sound card (133) to TV (102) (S15-S17). At this time, RGB signal of video card (132) is transmitted as converted NTSC mode composite video signal. Thus, basic menu screen is displayed provided by contents provider (140) on TV (102).

In addition, when user watches basic menu screen of TV (102) and operates remote control's (104) menu key or up/down/left/right direction key, set top box (106) receives and decodes this and transmits to PC (130). PC (130) transmits this signal to server (142), so user can choose contents wanted (S18-S23). At this time, since screen provided by exclusive browser (137) does not have address input window for web surfing different from general internet browser, user cannot connect to sites other than offered by exclusive contents sites as default. Since it is composed to choose menu within screen provided at server (142), complicated input device is not needed such as wireless keyboard or wireless mouse. And because one can operate easily with remote control (104) with simple keys like power key, menu key, up/down/left/right direction key, people without much knowledge with internet or computer can use easily. Futhermore, when contents selected by user is a toll site, excess charge begins according to agreement.

When user operates remote control (104) and turns power off, set top box (106) transmits off request signal to PC. After receivng off request signal, PC transmits log out request signal to server (142) and off consent signal to set top box (106), and then turns off PC (130) automatically. After off consent signal is received, set top box (106) converts TV controller (113) to stand by mode and blocks video signal and audio signal.

Drawing 4 is a flow diagram illustrating steps software of main set top box executing according to this invention.

Referencing to drawing 4, when software built in micro processor (111) executes after power is on, set top box (106) processes self-diagnosis and initial step, then stand by for event occurrence (401-403). At this time, indicate movement state to user by turning on power LED indicating power on state and LED indicating movement state.

When set top box power on signal is received through infrared sensor (121) from remote control (104) during stand by, transmit operating request signal to PC (130) (406, 407) and transmit serial number to PC (130) after code request signal from PC (130) is received (404, 405).

When operating consent signal is received during stand by, operate TV controller (113) using controller signal (408, 409) and transmit off request signal to PC (130) after set top box power off signal is received (412, 413).

Drawing 5 is a flow diagram illustrating steps software of pc set top box executing according to this invention.

Referencing to drawing 5, PC set top box operating software (135) requires serial number to set top box (106) at initial installation, logs in to server (142) after serial number is received, and registers entering serial number and subscriber information (501-505).

When operating request signal is received from set top box (106) after registration is completed, execute set top box operating software (135) after waking up and request serial number to set top box (106).

After serial number is received, connect to server (142) and request for log in transmitting log in information like serial number, subscriber ID, and password (510-512).

When log in is granted from server (142), view contents provided by contents provider (140) by running exclusive browser (137), and transmit operating consent signal to set top box (106) (513-515).

When power off call signal is received from set top box (106), request for log out connecting to server (142), transmit power off consent signal to set top box (106) and turn PC (519) off (516-519). Here, even PC (130) is turned off, basic devices to communicate with set top box (106) need to be at stand by mode.

On other side, if system timer is set at fixed time interval to prevent user to connect to different sites other than exclusive sites allowed by set top box using public internet browser, then verify operation status of exclusive browser when timer interruption occurs and let exclusive browser to appear on screen first (520, 521).

Drawing 6 is a flow diagram illustrating steps server executes according to this invention.

Referencing to drawing 6, if optional PC (130) is connected and is first connection, register information like serial number, subscriber personal information, ID, and password at data base (144) (601, 602).

When log in is requested after registration, allow log in after verifying log in information like serial number, subscriber ID, password and if it matches previously registered information. If it does not match, then do not allow log in (603, 604).

When log in is successful, provide basic web page to choose contents (605, 606). Provide relevant contents when user chooses contents, and start charging fee following preset method when it is fee based (607, 608). Stop providing contents when log out is requested, process log out, and stop charging fee (609, 610).

Drawing 7, as an example of exclusive browser screen according to this invention, is an example of basic screen appearing after log in to contents provider (140) through set top box.

Referencing to drawing 7, contents items (DVD, VOD, my video, today's movie) movable by menu button are displayed on bottom of screen. Title that can be chosen by up/down key is displayed on right side of screen, and a screen to choose channel with left/right direction key is displayed on a section.

Like this, exclusive browser according to this invention blocks internet surfing route and can limit user linking other internet sites since offering simple link set up menu only. Also, there is an advantage of operation being very simple since user can find wanted contents with direction key or menu key only at basic menu screen.

Drawing 8 is a diagram to describe filter concept of mouse and keyboard provided according to this invention. This kind of filter technology is to block user with double monitors viewing other contents than exclusive contents allowed by set top box.

Referencing to drawing 8, input/output device (801) like keyboard or mouse gets processed first at system's first bios (basic input output system) (802), and contents processed at bios (802) get processed again at operating software (803) and transmitted to appropriate practical program (805). At this time, keyboard and mouse filter (804) according to this invention are located between operating system (803) and practical program (805) and block newly executed program coming over to TV domain by limiting movement of computer input device keyboard and mouse.

### Industrial Applicability

As explained above, only internet sites allowed by PC based TV set top box installed between PC and TV and set top box operating software installed at PC are linked and offered contents exclusively, and sites that are not allowed can be blocked from linking. Using this kind of feature, business stability is guaranteed providing contents exclusively to user after contents provider distributes set top box at free of charge of very low cost to public. From user standpoint, since operation is very simple, user can use contents easily even without knowing how to use internet or computer. Furthermore, since serial number is stored at set top box, and serial number and user ID or password are used together at the time of certification at server or PC, illegal usage from set top box theft or illegal usage from software duplication can be prevented.

What is claimed:

1. PC equipped with operating software to operate exclusive browser and set top box registers serial number and subscriber information to special site at first installation, requests for log in after operating request signal received from set top box communicating parallel with set top box, operates exclusive browser when log in is approved, and transmits operating permission to set top box,
Key input device inputted by user to operate set top box; and
PC based TV set top box system specially composed of set top box which links TV and above PC, requests for operation communicating with above PC after receiving signal from above key input device, provides preset serial number after receiving serial input request signal from above PC, and operates normally when operation consent signal is received from above PC and transmits personal computer's video signal and audio signal to above television.

2. From item 1, above set top box is
TV controller converting R,G,B signal inputted from above personal computer's video card to composite video signal, linking or blocking audio signal inputted from above personal computer's sound card,
Sensor to detect operation of above key input device;
PC based TV set top box system specially composed of micro processor which communicates through parallel port with above PC, transmits decoded signal to personal computer after receiving operating signal from above sensor, operates above TV controller at normal mode when operating consent signal is transmitted from above personal computer, and controls above TV controller to operate at stand by mode when off consent signal is received.

3. Above set top box at item 1 is
Separated to main set top box connected to computer and server set top box connected to television, main set top box and server set top box are connected by cable,
Above main set top box is,
Composed of TV controller which converts R,G,B signal inputted from above personal computer's video card to composite video signal, connects or blocks audio signal inputted from above personal computer's sound card, and micro processor which communicates with above personal computer through parallel port, transmits decoded signal to above pc when operating signal is received from sensor, operates TV controller at normal mode when operating consent signal is received from above PC, and controls above TV controller to operate at stand by mode when off consent signal is received,
Above server set top box is,
Sensor to detect above key input device operation, and PC based TV set top box system composed of audio and video terminal with special feature of connecting computer and television located at different location.

4. At item 2 or item 3, above sensor is PC based TV set top box system having infrared sensor as special feature.

5. At item 2 or item 3, above set top box is PC based TV set top box system with special feature of having more buffer to separate and send R,G,B signal inputted from above personal computer's video card to set top box and monitor.

6. At item 1, above set top box system is PC based TV set top box system with special feature of including more contents provider sites to include server and data base, manage subscriber information linked to above personal computer and internet, and to provide contents exclusively.

7. At item 1, above key input device is PC based TV set top box system specially composed of remote control.

8. At system where personal computer's screen is displayed at above television by connection personal computer and television through set top box, and system where above personal computer can connect to exclusive contents site through internet,
Step registering serial number built in above set top box and subscriber information at above contents providing sites;
Step where set top box communicates with above personal computer after operating request signal is received from input device, transmits serial number, and request for operation;
Step where personal computer connects to above site and transmits serial number and information to log in;
Step where above site compares serial number received and registered log in information and permits log in if they match;
Step where above personal computer operates exclusive browser after receiving log in permission from above site, receives above site's web page, and operates permitting to above set top box; and
Offering method contents exclusively using PC based TV set top box system with special feature including step transmitting and indicating video signal and audio signal received from above personal computer to television.

9. At item 8, above exclusive contents offering method is offering method contents exclusively using PC based TV set top box system with special feature of indicating private browser to top priority order at regular time interval.

10. At item 8, above serial number is special number of designated unit stored at set top box at the time of manufacturing, and above subscriber information is offering method contents exclusively using PC based TV set top box system with feature including subscriber ID and password.

11. At item 8, above private browser is exclusively contents offering method using PC based TV set top box system which can limit user to connect to other sites on internet since providing simple link set menu and can find desired contents with direction key or menu key at basic menu screen.
